(19) United States
(12) Patent Application Publication
(10) Pub. No.: US 2004/0262814 A1
(43) Pub. Date: Dec. 30, 2004

(54) Method for reducing the toughness of shaped plastic parts to be mechanically worked and the use thereof

(76) Inventors: Ekkhard Beer, Bad Schwalbach (DE); Wolfram Goerlitz, Wiesbaden (DE); Dirk Heukelbach, Weiterstadt (DE)

Correspondence Address: CONNOLLY BOVE LODGE & HUTZ, LLP, P O BOX 2207, WILMINGTON, DE, 19899, US

(21) Appl. No.: 10/493,353

(22) PCT Filed: Oct. 19, 2002
(86) PCT No.: PCT/EP02/11741

(30) Foreign Application Priority Data
Oct. 25, 2001 (DE) 101 52 146.4

(51) Int. Cl. C08J 5/00

(52) U.S. Cl. 264/331.15

(57) ABSTRACT

The present invention relates to a process for reducing the toughness of moldings made from plastic, which comprises melting and mixing at least one semicrystalline polymer and at least one amorphous polyolefin in a heatable mixing assembly, processing the resultant mixture to give a polymer molding composition, and processing the polymer molding composition to give moldings. The moldings have improved machining properties.

Machining is still used on a wide variety of moldings made from plastic. A large number of these parts were produced from polyvinyl chloride (PVC), and to some extent this is still true today. However, attempts are being made to use polyolefins and other semicrystalline polymers to replace this material, for reasons of environmental protection and costs.

However, a disadvantage here is the high toughness of these polymers. Although this is desirable for a large number of applications, it is disadvantageous during machining of the plastic, because shavings do not automatically break off during operations on a material with this property. The raised shaving therefore often remains on the workpiece molding and has to be removed in a further step. Furthermore, this often leaves sharp edges which increase the risk of injury. This is a considerable disadvantage during the production of writing implements, such as pencils, but in particular of sharpenable cosmetics sticks, such as eyeliner.

In the current prior art, this desired embrittlement can be brought about by adding additives, such as inorganic and/or organic fillers, in particular mineral fillers. However, a disadvantage here is the increase in the viscosity of the resultant polymer molding composition, and also greater stress on the cutting edge of the cutter. This becomes blunt more rapidly, and the tool has reduced service life.

The object of the invention consists in eliminating the disadvantages of the prior art, using simple means.

This object is achieved via a process for reducing the toughness of moldings made from plastic, which comprises melting and mixing at least one semicrystalline polymer and at least one amorphous polyolefin in a heatable mixing assembly, processing the resultant mixture to give a polymer molding composition, and processing the polymer molding composition to give moldings.

Surprisingly, it has been found that the desired reduction in toughness of the semicrystalline polymer can be achieved via mixing with an amorphous polyolefin. These amorphous polyolefins do not form a homogeneous mixture with other semicrystalline polymers, the result being an increase in the brittleness of the parent material. In one advantageous embodiment of the present invention, the degree of brittleness can be adjusted as desired via use of amorphous polyolefins with certain glass transition temperatures. In addition, selection of the glass transition temperatures can provide a means of adaptation to the melting behavior and softening behavior of the semicrystalline polymer. This makes subsequent processing easier, because when the polymer molding composition subsequently melts for processing the additive used according to the invention, the amorphous polyolefin, likewise melts.

The invention also provides the use of the moldings produced by the inventive process for machining.

In principle, the semicrystalline polymers which may be used comprise any of these materials, preference being given to polyolefins, polyesters, and polyamides. By way of example, suitable materials are semicrystalline polyolefins. These materials are described by way of example in Saechtling, Kunststoff-Taschenbuch [Plastics Handbook], Hanser-Verlag, 27th edition 1998 on pages 375 to 413, incorporated herein by way of reference. These are generally polymers of ethylene or of α-olefins, such as propene, n-butene, isobutene, or of higher α-olefins, or are copolymers prepared therefrom. Use may advantageously be made of polyolefins prepared from monomers having from 2 to 6 carbon atoms, in particular polypropylene, polyethylenes such as HDPE, LDPE, and LLDPE. It is also possible to use mixtures of two or more semicrystalline polyolefins. Where appropriate, the semicrystalline polyolefin comprises other additives, added in amounts that are respectively effective.

Examples of other suitable semicrystalline polymers are polyesters, in particular thermoplastic polyesters, and also mixtures of these. These contain polymerized units which derive from esters of at least one aromatic dicarboxylic acid, in particular terephthalic acid, isophthalic acid, or else 2,6-napthalenedicarboxylic acid, and from at least one aliphatic diol, in particular ethylene glycol, 1,3-propanediol, 1,4-butanediol, or contain the polymerized units of tetrahydrofuran or polyethylene glycol. Examples of suitable polyesters are described in Ullmann's Encyclopedia of Ind. Chem., ed. Barbara Elvers, Vol. A24, Polyester section (pp. 227-251) VCH Weinheim-Basle-Cambridge-New-York (1992), incorporated herein by way of reference. Preference is given to polyesters such as polyethylene terephthalate (PET) or polybutylene terephthalate (PBT), and also copolyesters which contain butylene terephthalate units and butylene isophthalate units. The polyesters may also have been modified via copolymerization of aliphatic dicarboxylic acids, such as glutaric acid, adipic acid, or sebacic acid, or by copolymerization of polyglycols, such as diethylene glycol or triethylene glycol, or other relatively high-molecular-weight polyethylene glycols. The polyesters may likewise contain other polymerized units which may derive from hydroxycarboxylic acids, preferably from hydroxybenzoic acid or from hydroxynaphthalenecarboxylic acid.

Examples of suitable polyamides are described in Saechtling, Kunststoff-Taschenbuch [Plastics Handbook], Hanser-Verlag, 27th edition 1998 on pages 465 to 478. Polyamides have the formula

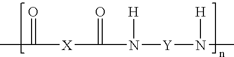

where X and Y may be identical or different and are an aromatic or aliphatic radical. The aromatic radicals generally have meta- or para-substitution. Aliphatic radicals are mostly unbranched, linear or cyclic radicals, but it is also possible to prepare and use materials having branched radicals. The aliphatic radicals are preferably linear, unbranched, and have from 4 to 13 carbon atoms. Particularly preferred polyamides are materials where X is a linear aliphatic radical having 4, 7, 8 or 10 carbon atoms and Y is a linear, aliphatic radical having 4 or 6 carbon atoms. In another advantageous embodiment, use is made of a polyamide in which X is a para- or meta-substituted phenyl radical and Y is a linear, aliphatic radical having 6 carbon atoms, or a 2,2-dimethyl-4-methylhexyl radical.

n is an integer greater than 1, preferably from 2 to 1000, in particular from 80 to 100.

Other advantageous polyamides have the formula

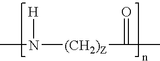

where Z is 5, 10 or 11 and n is greater than 1, but preferably from 2 to 1000, in particular from 80 to 100. The properties, preparation, and processing of these materials are well known to the person skilled in the art.

Although polycarbonates are not semicrystalline, the same problem arises with these polymers, namely the poor break-away of shavings due to the toughness of the polymer, and this problem can be eliminated in the same way via mixing with at least one amorphous polyolefin. Polycarbonates are described by way of example in Saechtling, Kunststoff-Taschenbuch [Plastics Handbook], Hanser-Verlag, 27th edition 1998 on pages 479 to 485. By way of example, polycarbonates may be prepared via reaction of bisphenol A with phosgene or via melt condensation of diphenyl carbonate with bisphenol A. Possible comonomers are bisphenol TMC and bisphenol S (dihydroxydiphenyl sulfide). The flame retardancy of these materials may be improved via use of halogenated bisphenol derivatives, in particular bromine-containing bisphenol derivatives.

Suitable polycarbonates mostly have the formula

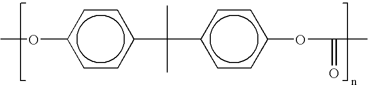

and may likewise have repeat units of the structure

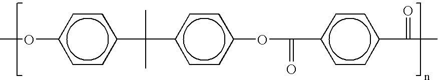

where n is greater than 1 and preferably from 2 to 10 000. Particular preference is given to polycarbonates in which n has been adjusted so that the average molar mass does not exceed 30 000 g/mol.

These materials may contain bisphenol units which may have been substituted on the aromatic ring, for example by bromine, or which bear different aliphatic radicals on the carbon atom which connects the aromatic rings (bisphenol-TMC-containing polycarbonates, for example), or in which the aromatic rings have connection by a heteroatom, such as sulfur (bisphenol-S-containing materials).

For the purposes of the present invention, amorphous polyolefins are polyolefins which are solids at room temperature, despite lacking regularity in arrangement of the molecular chains. Their degree of crystallinity is generally below 5%, preferably below 2%, or is 0%, determined by X-ray diffractometry. Particularly suitable amorphous polymers are those whose glass transition temperature Tg is in the range from −50 to 250° C., preferably from 0 to 220° C., in particular from 40 to 200° C. The amorphous polyolefin generally has an average molecular weight Mw in the range from 1000 to 10 000 000, preferably from 5000 to 5 000 000, in particular from 5000 to 1 200 000. These molar masses determined by means of gel permeation chromatography (GPC) in chloroform at 35° C. with the aid of an RI detector are relative and are based on calibration using narrowly distributed polystyrene standards. The cycloolefin copolymers described here have viscosity numbers to DIN 53728 of from 5 to 5000 ml/g. Preference is given to viscosity numbers of from 5 to 2000 ml/g, and particular preference is given to viscosity numbers of from 5 to 1000 ml/g. The refractive index of the amorphous polymer is generally in the range from 1.3 to 1.7, preferably from 1.4 to 1.6. Amorphous polyolefins which may be used with particular advantage are cycloolefin copolymers and cycloolefinic polymers, individually or as a mixture. Suitable cycloolefin copolymers are known per se and are described in EP-A-0 407 870, EP-A-0 485 893, EP-A-0 503 422, and DE-A-40 36 264, expressly incorporated herein by way of reference. The cycloolefin polymers used have a structure composed of one or more cycloolefins, the cycloolefins used generally comprising substituted and unsubstituted cycloalkenes and/or polycycloalkenes, such as bi, tri- or tetracycloalkenes. The cycloolefin polymers may also have branching. Products of this type may have a comb structure or star structure. Advantageous materials are copolymers made of ethylene and/or an α-polyolefin with one or more cyclic, bicyclic and/or polycyclic olefins. A particularly advantageous material is the amorphous polyolefin derived from at least one of the cyclic or polycyclic olefins of the formulae I to VII

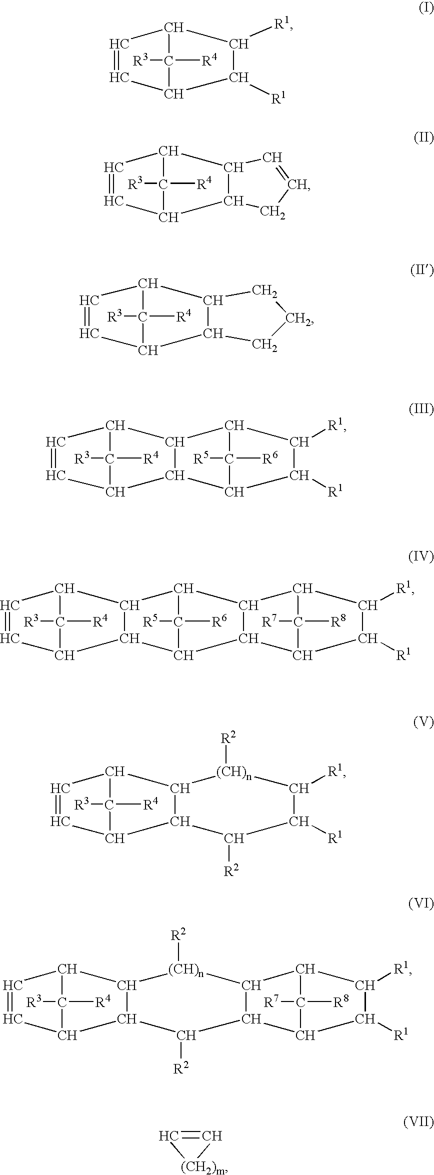

where the radicals R¹,R²,R³,R⁴,R⁵,R⁶,R⁷, and R⁸ of the formulae I to VI may be identical or different, and are H, C6-C20-aryl, C1-C20-alkyl, F, Cl, Br, or I, n is an integer from 0 to 5, and m is an integer from 2 to 10. A very particularly advantageous amorphous polyolefin which may be used is a copolymer made from ethylene and norbornene. The cycloolefin copolymers are preferably prepared with the aid of transition metal catalysts which have been described in the abovementioned specifications. Preferred preparation processes here are those of EP-A-0 407 870 and EP-A-0 485 893, because these processes give cycloolefin polymers with a narrow molecular weight distribution (Mw/Mn=2). This avoids disadvantages such as migration, extractability, or tack possessed by or resulting from the low-molecular-weight constituents. Regulation of molecular weight during the preparation is achieved via the use of hydrogen, careful selection of the catalyst, and of the reaction conditions.

A plastic whose toughness has been reduced by the inventive process generally comprises at least 50% by weight, preferably from 90 to 75% by weight, in particular from 95 to 75% by weight, of the semicrystalline polymer.

In principle, any mixing assembly suitable for the purpose may be used to mix the semicrystalline polymer and the amorphous polyolefin. Suitable mixing assemblies and mixing processes are described in: Saechtling, Kunststoff-Taschenbuch [Plastics Handbook], Hanser-Verlag, 27th edition 1998, on pages 202 to 217, incorporated herein by way of reference. The mixing may be carried out in kneaders, for example, and mention may be made here of Brabender kneaders, merely by way of example. In one preferred embodiment of the inventive process, the mixing assembly is composed of at least one screw-based machine. In one particularly preferred embodiment, the screw-based machines used comprise extruders, in particular twin-screw extruders. The melt temperatures are within the ranges conventional for the particular semicrystalline polymers used: for example, in the case of LDPE the range is advantageously from 160 to 260° C., in the case of HDPE from 260 to 300° C., and in the case of polypropylene mostly from 220 to 270° C.

In principle, any suitable process may be used to produce the moldings. Suitable processes are described in Saechtling, Kunststoff-Taschenbuch [Plastics Handbook], Hanser-Verlag, 27th edition 1998, on pages 201 to 369, incorporated herein by way of reference. Advantageous production methods are injection molding, injection-compression molding, extrusion, or compression molding. A particularly advantageous process is one in which the melting and mixing, and also the shaping, take place in one operation. In a process of this type, a single apparatus is used for the production of the moldings and the mixing of the amorphous and the semicrystalline polyolefin. By way of example, the mixing may be carried out in the extruder also used to carry out the extrusion of the molding, or else in an injection-molding apparatus.

Machining means the operations described in Dubbels Taschenbuch des Maschinenbaus [Dubbel's Engineering Manual], Springer-Verlag, 12th edition 1963, second volume, on pages 631 to 660, incorporated herein by way of reference. Other suitable processes are those which can be carried out using the apparatuses described in that publication. Advantageous processes are turning, planing, drilling, sawing, milling, grinding, broaching, chiseling, in particular screw-thread cutting, gearwheel-milling, gearwheel-cutting, precision turning, precision drilling, and precision milling.

Examples of inventive moldings are carriers for the material to be applied in cosmetics sticks, for example a stick for applying eyeliner and the like, or else pencils, composed of a graphite lead or the like in the interior and externally of the semicrystalline polymer whose toughness has been reduced by the inventive process. These pencils and sticks may be produced in any conceivable shapes and forms, and can be sharpened without leaving sharp edges.

### EXAMPLE

A mixture of 85% of polypropylene and 15% of an ethylene-norbornene copolymer (Topas 6013 from Ticona GmbH, Kelsterbach) was extruded and the extrudate was then cut into pieces of length 15 cm. The shaving produced on sharpening with a pencil sharpener breaks away from the test specimen leaving no sharp edge.

### Comparative Example

Test specimens were extruded from pure polypropylene. Because the polypropylene has high toughness, break-off of the shaving was difficult and a sharp edge is produced.

1. A process for reducing the toughness of moldings made from plastic, which comprises melting and mixing at least one semicrystalline polymer and at least one amorphous polyolefin in a heatable mixing assembly, processing the resultant mixture to give a polymer molding composition, and processing the polymer molding composition to give moldings.

2. The process as claimed in claim 1, wherein said at least one semicrystalline polymer comprises at least one polyolefin, polyamide, polyester or a copolymer of these, or a mixture made from these.

3. The process as claimed in claim 1, wherein the mixing assembly is a screw-based machine.

4. The process as claimed in claim 1, wherein the processing of the polymer molding composition to give moldings takes place by injection molding, extrusion, injection-compression molding, or compression molding.

5. The process as claimed in claim 1, wherein the processing the polymer molding composition is a shaping and the melting and mixing, and also the shaping, take place in one operation.

6. The process as claimed in claim 1, wherein the amorphous polyolefin used comprises a cycloolefin copolymer or a cycloolefinic polymer, individually or as a mixture.

7. The process as claimed in claim 1, wherein the amorphous polyolefin used comprises a copolymer made from ethylene and/or from an α-polyolefin with one or more cyclic, bicyclic and/or polycyclic olefins.

8. The process as claimed in claim 1, wherein the amorphous polyolefin has been derived from at least one of the cyclic or polycyclic olefins of the formulae I to VII 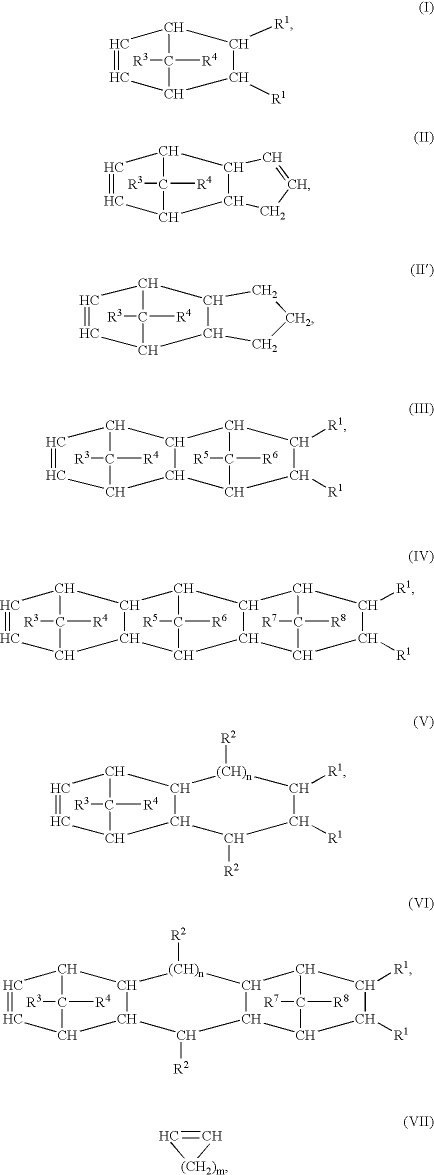
where the radicals R¹,R²,R³,R⁴,R⁵,R⁶,R⁷ and R⁸ of the formulae I to VI may be identical or different and are H, C₆-C₂₀-aryl, C₁-C₂₀-alkyl, F, Cl, Br, or I, n is an integer from 0 to 5, and m is an integer from 2 to 10.

9. The process as claimed in claim 1, wherein the amorphous polyolefin used comprises a copolymer made from ethylene and norbornene.

10. cancelled.

11. The process as claimed in claim 1, wherein the molding is a cosmetic stick or a pencil.

12 and 13. cancelled.

14. A mixture made from thermoplastic polymers comprising at least one cycloolefin copolymer, which comprises at least one polymer selected from the group consisting of polyesters, polyamides, and polycarbonates.

15 A process for reducing the toughness of moldings made from plastic, which comprises melting and mixing at least one a polycarbonate and at least one amorphous polyolefin in a heatable mixing assembly, processing the resultant mixture to give a polymer molding composition, and processing the polymer molding composition to give moldings.

16. A machining which comprises the moldings produced by the process as claimed in claim 1.

17. The machining as claimed in claim 16, wherein the machining is by turning, planing, drilling, sawing, milling, grinding, broaching, chiseling, screw-thread cutting, gearwheel-milling, gearwheel-cutting, precision turning, precision drilling, or precision milling.
